(19) United States
(12) Patent Application Publication
(10) Pub. No.: US 2008/0103279 A1
(43) Pub. Date: May 1, 2008

(54) Use of Polymers for Up-Conversion, and Devices for Up-Conversion

(75) Inventors: Susanne Heun, Bad Soden (DE); Arne Busing, Frankfurt am Main (DE); Esther Breuning, Niedernhausen (DE); Aurelie Ludemann, Frankfurt (DE); Chan Im, Seoul (KR); Frederic Laquai, Cambridge (GB)

Correspondence Address: CONNOLLY BOVE LODGE & HUTZ, LLP, P O BOX 2207, WILMINGTON, DE, 19899, US

(73) Assignee: Merck Patent GmbH, Darmstadt (DE)

(21) Appl. No.: 11/632,338

(22) PCT Filed: Jul. 14, 2005
(86) PCT No.: PCT/EP05/07671

§ 371 Date: Jul. 25, 2007

(30) Foreign Application Priority Data
Jul. 15, 2004 (DE) 10 2004 034 140.0

(51) Int. Cl. C08G 79/08

(52) U.S. Cl. 528/8

(57) ABSTRACT

The present invention relates to systems for photoenergy up-conversion comprising polymers and sensitisers, where the triplet level of the polymer is lower than the triplet level of the sensitiser. These systems exhibit higher efficiency in up-conversion and are therefore more suitable for use in devices for up-conversion than polymers as used in accordance with the prior art.

The phenomenon of “up-conversion”, i.e. the generation of photons of higher energy by simultaneous or sequential absorption of two or more photons of lower energy, has already been observed in a number of organic materials (T. Kojei et al., Chem. Phys. Lett. 1998, 298, 1; G. S. He et al., Appl. Phys. Lett. 1996, 68, 3549; R. Schroeder et al., J. Chem. Phys. 2002, 116, 3449; J. M. Lupton, Appl. Phys. Lett. 2002, 80, 186; C. Bauer et al., Adv. Mater. 2002, 14, 673). This phenomenon is frequently associated with the use of relatively high light intensities from pulsed lasers. Mechanisms that have been described for this are two-photon absorption by molecules having a high two-photon absorption cross section (a nonlinear optical effect), excitation into more excited states by high pump intensities or multistep excitation processes. Since the utilisation of these mechanisms is associated with relatively high costs, it represents a hindrance to practical use. However, this would be very desirable since it is often only the higher-energy part of the spectrum (blue) that is effective for applications. Up-conversion enables the lower-energy redder part of the spectrum to be utilised too. Thus, one possible use for up-conversion is in the area of organic solar cells (O-SCs). It is thus possible to use not only blue and UV light to produce free charge carriers from light, but also green or even red light if higher-energy blue light or where possible directly the free charge carriers can be produced therefrom. A further application is in the area of organic light-emitting diodes, for example for the generation of blue light or for the generation of white light by simultaneous emission of blue and red/yellow. However, further applications are also possible, for example in the area of organic blue lasers, which can be pumped with commercially available green lasers. Thus, the scattering and linear absorption can be reduced and the photostability of the material increased. A further possible application is, for example, in crosslinking reactions, where, through the use of green light, it is possible to generate UV light, whose action on a sensitiser is able to initiate the crosslinking reaction. Still a further possible application is in switches, where only a certain wavelength at which a relatively narrow-band sensitiser absorbs triggers the emission of blue light. Also possible are systems for optical data storage, chemical sensors, temperature sensors, biological and medical applications, etc.

Up-conversion was recently described in a system comprising a methyl-substituted conductor polymer (MeLPPP) doped with platinum octaethylporphyrin (PtOEP) as sensitiser (S. A. Bagnich, H. Bässler, Chem. Phys. Left. 2003, 381, 464) on polyfluorene doped with palladium octaethylporphyrin (PdOEP) as sensitiser (EP 1484378) and on polyfluorene doped with metal(II) octaethylporphyrin (P. E. Keivanidis et al., Adv. Mater. 2003, 15, 2095). The presence of the metal complex enabled the pump intensities of the laser to be reduced by five orders of magnitude compared with up-conversion on simple polyfluorene systems which did not comprise metal complexes. However, the efficiency of the up-conversion is still low; the ratio of the integrated photoluminescence of the polyfluorene on excitation of the metal complex compared with direct excitation of the polyfluorene was determined as 1:5000 for palladium porphyrin. The use of platinum porphyrin enabled the efficiency to be improved by a factor of 18, giving a ratio of approximately 1:300. However, the emission of the metal complex is predominantly obtained in these systems, as to be expected of a classical matrix-guest system.

The system comprising polyfluorene and metal porphyrin complex as sensitiser thus already enabled the up-conversion efficiency to be significantly increased. However, it would be desirable for the application to achieve a further significant increase in up-conversion and further to reduce the emission by the heavy metal-containing compound. The object of this work was thus to increase the up-conversion efficiency from 1:5000 or 1:300 by at least an order of magnitude to greater than 1:30.

Surprisingly, it has been found that polymers together with compounds containing heavy atoms (sensitiser) have properties with respect to the up-conversion efficiency which are very good and are superior to the prior art in particular if the lowest triplet level of the sensitiser is higher than the lowest triplet level of the polymer. This enabled the up-conversion efficiency to be increased by more than an order of magnitude (from 1:300 to greater than 1:30).

Furthermore, it has been found, surprisingly, that polymers containing condensed aromatic ring systems together with compounds containing heavy atoms (sensitiser) have properties with respect to the up-conversion efficiency which are likewise very good and are superior to the prior art.

The present invention therefore relates to the use of systems of this type for up-conversion and to optical and electronic devices containing these systems for up-conversion.

The invention therefore relates to the use of systems comprising at least one polymer and at least one sensitiser containing at least one heavy atom, characterised in that the triplet level of the sensitiser is higher than the triplet level of the polymer, preferably at least 0.05 eV higher, particularly preferably at least 0.1 eV higher, for up-conversion.

For the purposes of this invention, the term “up-conversion” is taken to mean the generation of photons of higher energy or electronic states of higher energy after absorption of photons of lower energy. In the systems according to the invention, it can proceed by known and described mechanisms or as described in P. E. Keivanidis (Adv. Mater. 2003, 15, 2095). This term is likewise taken to mean the generation of higher-energy photons from electrically generated excited states of lower energy. The invention furthermore relates to the use of systems comprising at least one polymer and at least one sensitiser containing at least one heavy atom, characterised in that the polymer contains at least 1 mol %, preferably at least 5 mol %, particularly preferably at least 10 mol %, of a condensed aromatic ring system for up-conversion, in particular in electronic and/or optical devices.

In a preferred embodiment of the invention, the triplet level of the sensitiser is higher than the triplet level of the polymer and at the same time the polymer contains at least 1 mol %, preferably at least 5 mol %, particularly preferably at least 10 mol %, of a condensed aromatic ring system.

The triplet energy of a compound is taken to mean the energy difference between the lowest triplet state T1 and the singlet ground state S0. The position of the singlet ground state S0 is preferably determined by means of cyclic voltammetry by determination of the oxidation potential (energy level of the HOMO) relative to a known standard. The energy difference between T1 and S0 is preferably determined by spectroscopy, as described, for example, by D. Hertel et al. (J. Chem. Phys. 2001, 115, 10007). The absolute position of the triplet level with respect to the vacuum potential E=0 is given by the sum of the energy of the ground state S0 (energy level of the HOMO) and the spectroscopically determined energy difference between T1 and S0.

For the purposes of this invention, a sensitiser is taken to mean a compound which absorbs light in the region of the incident wavelength, is thereby converted into a triplet state and is subsequently able, where appropriate, to transfer this to the polymer. The triplet level of the sensitiser here is preferably above the triplet level of the polymer.

The sensitiser preferably contains at least one heavy atom having an atomic number of greater than 38, preferably a transition metal having an atomic number of greater than 38, particularly preferably tungsten, ruthenium, osmium, rhodium, iridium, palladium, platinum or gold. The sensitiser can alternatively also be covalently linked to the polymer, meaning that it is then possible to use a single copolymer as up-conversion system.

For the purposes of this invention, a condensed aromatic ring system is taken to mean ring systems in which at least two aromatic or heteroaromatic rings, for example benzene rings, are “fused” to one another, i.e. condensed onto one another by anellation, i.e. have at least one common edge and thus also a common aromatic system. These ring systems may be substituted or unsubstituted; any substituents present may likewise form further ring systems. Thus, for example, systems such as naphthalene, anthracene, phenanthrene, pyrene, etc., are to be regarded as condensed aromatic ring systems, while, for example, biphenyl, fluorene, spirobifluorene, etc., are not condensed aromatic ring systems.

The polymer may be conjugated, partially conjugated or non-conjugated. In a preferred embodiment, the polymer is conjugated or partially conjugated; in a particularly preferred embodiment, the polymer is conjugated.

For the purposes of this invention, conjugated polymers are polymers which contain in the main chain principally sp²-hybridised (or also sp-hybridised) carbon atoms, which may also be replaced by corresponding hetero atoms. In the simplest case, this means the alternating presence of double and single bonds in the main chain. Principally means that defects occurring naturally (without further assistance) which result in conjugation interruptions do not devalue the term “conjugated polymer”. Furthermore, the term conjugated is likewise used in this application text if arylamine units, arylphosphine units and/or certain heterocycles (i.e. conjugation via N, O, S or P atoms) and/or organometallic complexes, such as, for example, iridium or platinum complexes (conjugation via the metal atom), are located in the main chain. For the purposes of this invention, partially conjugated polymers are polymers which either contain relatively long conjugated sections interrupted by non-conjugated sections in the main chain or which contain relatively long conjugated sections in the side chains of a polymer which is non-conjugated in the main chain. By contrast, units such as, for example, simple alkylene chains, (thio)ether bridges, ester, amide or imide links would clearly be defined as non-conjugated segments.

The condensed aromatic ring systems may, in accordance with the invention, be incorporated into the main chain and/or into the side chain of the polymer. In the case of incorporation into the side chain, it is possible for the ring systems to be in conjugation with the polymer main chain or for them to be non-conjugated with the polymer main chain. In a preferred embodiment of the invention, the condensed aromatic ring systems are in conjugation with the polymer main chain. In a particularly preferred embodiment of the invention, the condensed aromatic ring systems are part of the polymer main chain.

The condensed aromatic ring systems preferably contain between two and eight aromatic units, which are in each case condensed onto one another via one or more common edges and thus form a common aromatic system and which may be substituted or unsubstituted, where the substituents may form further ring systems. The condensed aromatic ring systems particularly preferably contain between two and six aromatic units, in particular between three and five aromatic units, which are in each case condensed onto one another via one or more common edges and thus form a common aromatic system and which may be substituted or unsubstituted, where the substituents may also form further ring systems.

The aromatic units condensed onto one another are very particularly preferably selected from benzene, pyridine, pyrimidine, pyrazine, pyridazine and thiophene, each of which may be substituted or unsubstituted, particularly preferably benzene and pyridine, each of which may be substituted or unsubstituted.

Possible substituents here are selected from C₁ to C₄₀ carbon-containing groups. For the purposes of the present invention, a C₁-C₄₀-carbon-containing group is preferably taken to mean the radicals C₁-C₄₀-alkyl, particularly preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₄₀-alkenyl, particularly preferably ethenyl, propenyl, butenyl, pentenyl, cyclopentenyl, hexenyl, cyclohexenyl, octenyl or cyclooctenyl, C₁-C₄₀-alkynyl, particularly preferably ethynyl, propynyl, butynyl, pentynyl, hexynyl or octynyl, C₁-C₄₀-fluoroalkyl, particularly preferably trifluoromethyl, pentafluoroethyl or 2,2,2-trifluoroethyl, C₆-C₄₀-aryl, particularly preferably phenyl, biphenyl, naphthyl, anthracenyl, triphenylenyl, [1,1′;3′,1″]terphenyl-2′-yl, binaphthyl or phenanthrenyl, C₆-C₄₀-fluoroaryl, particularly preferably pentafluorophenyl, 3,5-bistrifluoromethylphenyl, pentafluorobenzylidene, 3,5-bistrifluoromethylbenzylidene, tetrafluorophenyl or heptafluoronaphthyl, C₁-C₄₀-alkoxy, particularly preferably methoxy, ethoxy, n-propoxy, i-propoxy, n-butoxy, i-butoxy, s-butoxy or t-butoxy, C₆-C₄₀-aryloxy, particularly preferably phenoxy, naphthoxy, biphenyloxy, anthracenyl-oxy, phenanthrenyloxy, C₇-C₄₀-arylalkyl, particularly preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₄₀-alkylaryl, particularly preferably benzyl, ethylphenyl, propylphenyl, diphenylmethyl, triphenylmethyl or naphthalenyl-methyl, C₇-C₂₀-aryloxyalkyl, particularly preferably o-methoxyphenyl, m-phenoxy-methyl, p-phenoxymethyl, C₁₂-C₄₀-aryloxyaryl, particularly preferably p-phenoxy-phenyl, C₂-C₄₀-heteroaryl, particularly preferably 2-pyridyl, 3-pyridyl, 4-pyridyl, quinolinyl, isoquinolinyl, acridinyl, benzoquinolinyl or benzoisoquinolinyl, C₄-C₄₀-heterocycloalkyl, particularly preferably furyl, benzofuryl, 2-pyrrolidinyl, 2-indolyl, 3-indolyl, 2,3-dihydroindolyl, C₈-C₄₀-arylalkenyl, particularly preferably o-vinylphenyl, m-vinylphenyl, p-vinylphenyl, C₈-C₄₀-arylalkynyl, particularly preferably o-ethynyl-phenyl, m-ethynylphenyl or p-ethynylphenyl, C₂-C₄₀-hetero atom-containing group, particularly preferably carbonyl, benzoyl, oxybenzoyl, benzoyloxy, acetyl, acetoxy or nitrile, where one or more C₁-C₄₀-carbon-containing groups may form a cyclic system.

Examples of particularly preferred condensed aromatic ring systems are structures of the formulae (1) to (24), each of which has, in any desired positions, one, two or more links to the polymer, preferably two links to the polymer, and each of which may be substituted by one or more substituents R, where the number of substituents R corresponds at most to the number of substitutable H atoms:

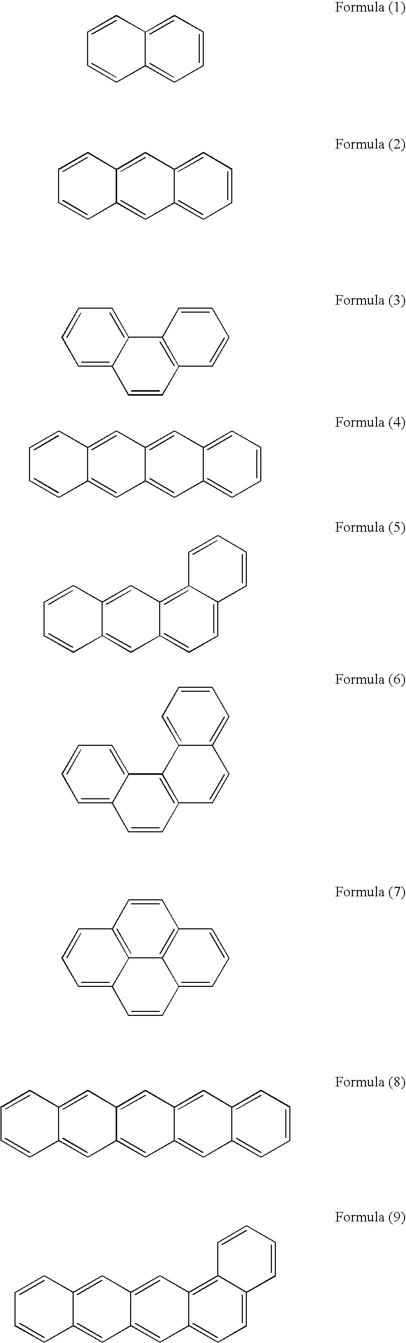

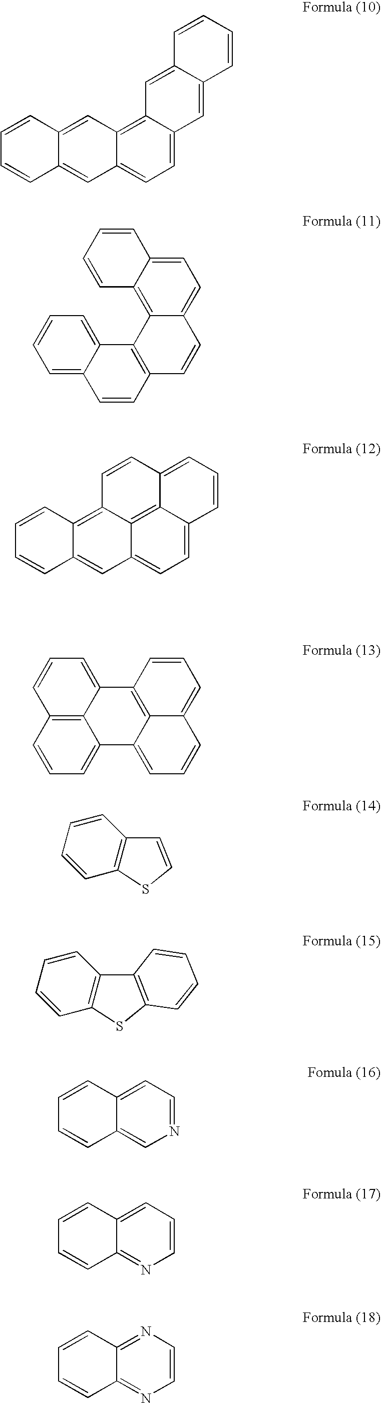

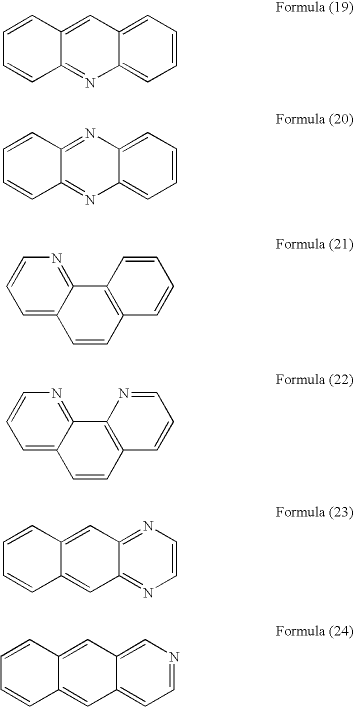

where the following applies to R:
R is on each occurrence, identically or differently, H, F, Cl, Br, I, NO₂, CN, a straight-chain, branched or cyclic alkyl or alkoxy group having 1 to 40 C atoms, in which one or more non-adjacent CH₂ groups may be replaced by C═O, C═NR¹, —R¹C═CR¹—, —C—C—, —O—, —S—, —NR¹—, Si(R¹)₂ or —CONR¹— and in which one or more H atoms may be replaced by F, Cl, Br, I, CN, NO₂, or an aromatic or heteroaromatic ring system having 4 to 40 C atoms, which may be substituted by one or more non-aromatic radicals R, or a combination of two to four of these groups; two or more substituents R here may together in turn define a further mono- or polycyclic, aliphatic or aromatic ring system;
R¹ is, identically or differently on each occurrence, H or an aliphatic or aromatic hydrocarbon radical having 1 to 20 C atoms; two or more radicals R¹ or R¹ together with R here may also define a further mono- or polycyclic, aliphatic or aromatic ring system.

For the purposes of this invention, an aromatic or heteroaromatic ring system is intended to be taken to mean a system which does not necessarily contain only aromatic or heteroaromatic groups, but instead in which a plurality of aromatic or heteroaromatic groups may also be interrupted by a short non-aromatic unit (less than 10% of the atoms other than H, preferably less than 5% of the atoms other than H), such as, for example, sp³-hybridised C, O or N atoms, etc. Thus, for example, systems such as 9,9′-spirobifluorene, 9,9-diarylfluorene, triarylamine, diaryl ether, etc., are also intended to be taken to mean aromatic ring systems for the purposes of this invention.

If the condensed aromatic ring systems or the units of the formulae (1) to (24) have only one link to the polymer, this means incorporation of these units into the side chain of the polymer. If the condensed aromatic ring systems or the units of the formulae (1) to (24) have two links to the polymer, this means incorporation of these units into the main chain of the polymer. If the condensed aromatic ring systems or the units of the formulae (1) to (24) have more than two links to the polymer, this means a branch of the polymer chain.

Besides the condensed aromatic ring systems, the polymers preferably also contain further structural elements. Reference should also be made here, in particular, to the relatively extensive lists in WO 02/077060 and the references cited therein. These further structural units may originate, for example, from the groups described below:

Group 1: Comonomers which represent the polymer backbone:

Units in this group are aromatic, carbocyclic structures having 6 to 40 C atoms. Fluorene derivatives (for example EP 0842208, WO 99/54385, WO 00/22027, WO 00/22026, WO 00/46321) come into consideration here. Spirobifluorene derivatives (for example EP 0707020, EP 0894107, WO 03/020790) are furthermore also a possibility. Polymers which contain a combination of the two first-mentioned monomer units, as disclosed in WO 02/077060, have also already been proposed. However, other structural elements which are able to influence the morphology, but also the emission colour of the resultant polymers are also possible. Preference is given here to substituted or unsubstituted aromatic structures which have 6 to 40 C atoms or also stilbene, bisstyrylarylene or tolan derivatives, such as, for example, 1,4-phenylene, tetrahydropyrenylene, dihydrophenanthrenylene, 4,4′-biphenylylene, 4,4″-terphenylylene, indenofluorenylene, 4,4′-stilbenyl, 4,4″-bisstyrylarylene or 4,4′-tolanylene derivatives. Preferred units for the polymer backbone are spirobifluorenes and fluorenes.

### Group 2: Comonomers having a high HOMO:

These are generally aromatic amines or electron-rich heterocycles, such as, for example, substituted or unsubstituted triarylamines, benzidines, tetraarylene-para-phenylenediamines, phenothiazines, phenoxazines, dihydrophenazines, thian-threnes, dibenzo-p-dioxins, phenoxathiynes, carbazoles, azulenes, thiophenes, pyrroles, furans and further O-, S- or N-containing heterocycles having a high HOMO (HOMO=highest occupied molecular orbital).

### Group 3: Comonomers having a low LUMO:

These are generally electron-deficient aromatics or heterocycles, such as, for example, substituted or unsubstituted pyridines, pyrimidines, pyridazines, pyrazines or oxadiazoles, but also compounds such as triarylboranes and further O-, S- or N-containing heterocycles having a low LUMO (LUMO=lowest unoccupied molecular orbital).

It is also permissible here for more than one structural unit from one of groups 1-3 to be present simultaneously.

The polymer may furthermore contain metal complexes, which are generally built up from one or more ligands and one or more metal centres, bonded into the main chain or side chain. If comonomers of this type are present, the use of separate heavy atom-containing compounds as sensitisers is not absolutely necessary in order to achieve good up-conversion efficiencies.

Preference is given to polymers which, besides condensed aromatic ring systems, simultaneously additionally contain one or more units selected from groups 1 to 3. Particular preference is given here to polymers which, besides condensed aromatic ring systems, also contain units from group 1, very particularly preferably at least 30 mol % of these units.

Preference is furthermore given to a proportion of 5-80 mol % of condensed aromatic ring systems. Particular preference is given to a proportion of 10-50 mol % of condensed aromatic ring systems.

The copolymers according to the invention can have random, alternating or block-like structures or also have a plurality of these structures in an alternating arrangement. It should likewise be emphasised at this point that the polymer can have a linear or branched structure or may also have dendritic structures.

The polymers according to the invention generally have 10 to 10,000, preferably 20 to 5000, particularly preferably 50 to 2000, recurring units.

The requisite solubility of the polymers is ensured, in particular, by the substituents on the various recurring units, both the substituents on the condensed aromatic ring systems and also by substituents on the other recurring units.

Polymers which contain spirobifluorene as backbone and may contain various condensed aromatic ring systems, and the synthesis of these monomer units and polymers, are described in detail, for example, in WO 03/020790.

The use of polymers whose triplet level is lower than the triplet level of the sensitiser used and/or which contain condensed aromatic ring systems produces a significant increase in up-conversion efficiency of more than an order of magnitude compared with the system comprising polyfluorene and platinum porphyrin (PtOEP) described in Adv. Mater. 2003, 15, 2095, to which this ratio of the triplet energies does not apply, which does not contain any condensed aromatic ring systems and which represents the closest prior art. This applies in particular if the triplet level of the polymer is lower than that of the sensitiser and if the polymer contains condensed aromatic ring systems. The precise mechanism of up-conversion in PtOEP-doped polyfluorene films has not been elucidated to date. It is therefore also not apparent why the phenomenon of up-conversion is more than an order of magnitude more efficient in the systems according to the invention than with simple systems in accordance with the prior art. The results described above are therefore unexpected and surprising. Without wishing to be tied to a particular theory, we assume that the triplet states transferred from the sensitiser to the polymer may possibly be subsequently annihilated there (triplet-triplet annihilation) and form an excited singlet state of the polymer, which then emits blue fluorescence. It is only through copolymerisation with condensed aromatic ring systems or other units which lead to a lower triplet level than that of the sensitiser that a significant increase in the up-conversion efficiency is obtained.

The invention furthermore relates to systems for up-conversion comprising at least one polymer and at least one sensitiser containing at least one heavy atom, characterised in that the triplet level of the sensitiser is higher than that of the polymer and/or in that the polymer contains at least 1 mol % of condensed aromatic ring systems. The preferences given above for the use of these systems also apply here.

The invention furthermore relates to optical and/or electronic devices for up-conversion comprising at least one polymer and at least one sensitiser containing at least one heavy atom, characterised in that the triplet level of the sensitiser is higher than that of the polymer and/or in that the polymer contains at least 1 mol % of condensed aromatic ring systems. These devices may be, for example, organic solar cells (O-SCs), but also other optical or electronic devices, for example organic light-emitting diodes (OLEDs) or organic lasers (O-lasers).

Although the descriptions given above only relate to systems comprising polymers, it is straightforward for the person skilled in the art to apply these descriptions to oligomers and dendrimers without further inventive step. The present invention thus also relates to the use of oligomers and dendrimers of this type.

The invention is explained in greater detail by the following examples, without wishing to restrict it thereto.

### EXAMPLES

### Example 1

### Monomer Syntheses

The structures of the monomers (M) are depicted below. The syntheses are described in WO 03/020790 and the literature cited therein.

9,10-Dibromoanthracene was obtained from Aldrich and purified further by recrystallisation from dioxane.

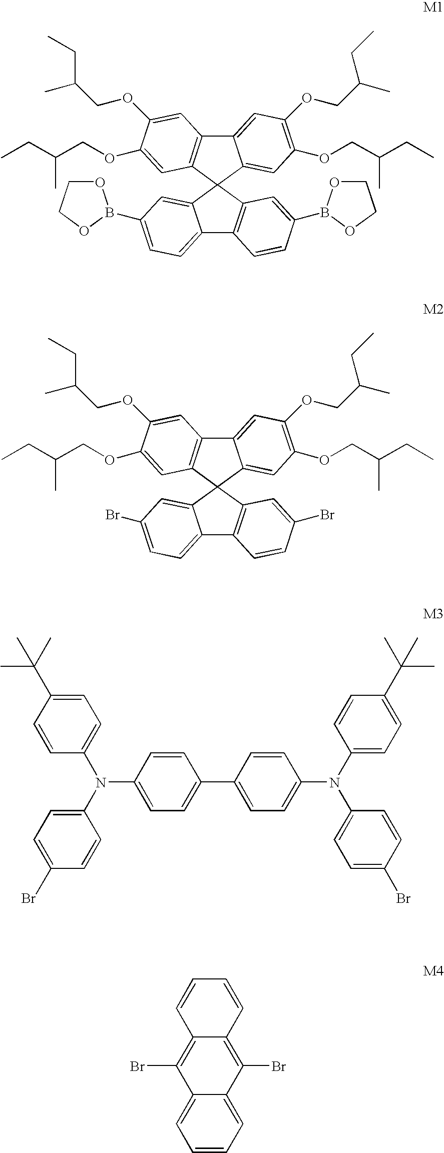

### Example 2

### Polymer Syntheses

The polymers were synthesised by SUZUKI coupling as described in WO 03/048225. The composition of polymer P1 used here is 50 mol % of M1, 10 mol % of M2, 10 mol % of M3 and 30 mol % of M4.

A comparative polymer C1 used was poly[2,7-(9,9-bis(2-ethylhexyl)fluorene)] (H. G. Nothofer et al., Macromol. Symp. 2000, 154, 139) in accordance with the closest prior art (P. E. Keivanidis et al., Adv. Mater. 2003, 15, 2095). A further comparative polymer C2 used was a spirobifluorene homopolymer comprising 50 mol % of M1 and 50 mol % of M2, which contains the same polymer backbone as polymer P1, but no condensed aromatic ring systems. Both comparative polymers are structurally and/or electronically similar to polymer P1.

### Example 3

### Determination of the Triplet Energies

The triplet energies of the compounds were determined by time-resolved photo-luminescence spectroscopy. Details on the experimental procedure are described in the literature (D. Hertel et al., J. Chem. Phys. 2002, 115, 10007).

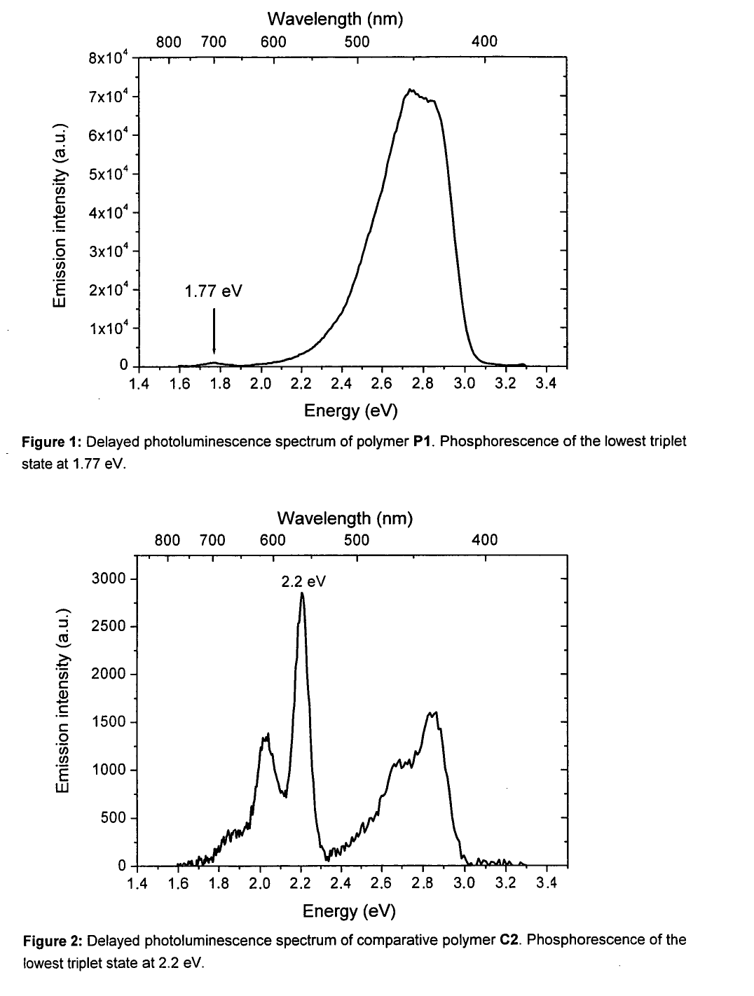

For the anthracene-spirobifluorene copolymer P1, the lowest triplet energy was determined spectroscopically as 1.77 eV (FIG. 1). The triplet energy of comparative polymer C1 is 2.18 eV, as described in the literature (D. Hertel et al., J. Chem. Phys. 2002, 115, 10007). The lowest triplet energy of comparative polymer C2 was determined spectroscopically as 2.2 eV (FIG. 2). The triplet energy of the sensitiser PtOEP in the test system described is 1.91 eV. The triplet energy of the sensitiser is thus higher than that of polymer P1, but lower than that of comparative polymers C1 and C2.

### Example 4

### Use of Polymer P1 and Comparative Polymers C1 and C2 in Up-Conversion

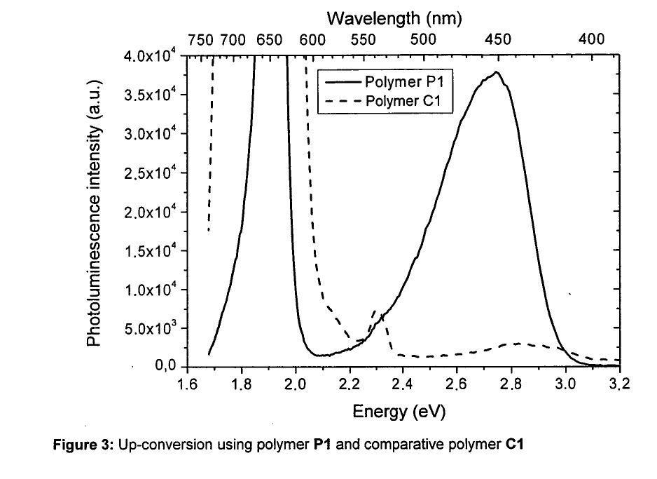

The test system investigated consisted of the anthracene-spirobifluorene copolymer P1 described in Example 2 or comparative polymers C1 and C2 doped with platinum octaethylporphyrin (PtOEP) in weight concentrations of 0.1 to 2.0% by weight (based on the polymer). For spectroscopic characterisation of the mixtures, thin films were produced on quartz substrates by spin coating. The samples were excited in an evacuated sample holder (10⁻⁶ mbar) with the aid of a pulsed OPO laser system with an energy of 2.31 eV (537 nm), corresponding to the S₀→S₁0-0 transition of PtOEP. The light emitted by the sample was spectrally dispersed by means of a spectrometer and detected by an optical multichannel analyser (OMA III, EG&G). For measurement of the up-conversion, a detection window of 10 ms with a delay of 50 ns with respect to the excitation pulse was selected. The typical excitation power was 50 μJ/pulse with a spot diameter of 2 mm. In order to improve the signal/noise ratio, over 100 laser pulses were accumulated. On excitation of the dopant PtOEP, a blue fluorescence of the polymer matrix was observed. This is not attributable to direct excitation of polymer P1, since this does not absorb at an excitation energy of 2.31 eV (537 nm). The luminescence must consequently be caused by the presence of the dopant. It was furthermore found in direct comparison that the intensity of the blue fluorescence is more intense by a factor of 10 (approx. from 1:300 to greater than 1:30) with polymer P1 than on use of a matrix comprising polyfluorene C1 (FIG. 3) in accordance with the prior art. The up-conversion in polymer P1 is thus an order of magnitude more efficient than described hitherto for blue-emitting conjugated polymers.

It has furthermore been found that the presence of anthracene in this copolymer is crucial for the position of the triplet level and thus for the improvement in the up-conversion efficiency. A comparison with a matrix comprising a polyspirobifluorene homopolymer C2 showed that up-conversion in this material is comparable with up-conversion in doped polyfluorene C1.

1-20. (canceled)

21. A System for up-conversion comprising at least one polymer and at least one sensitizer containing at least one heavy atom, wherein the triplet level of the sensitizer is higher than the triplet level of the polymer.

22. The system as claimed in claim 21, wherein the polymer contains at least 1 mol % of condensed aromatic ring systems.

23. The system as claimed in claim 21, wherein the triplet level of the sensitizer is higher than the triplet level of the polymer and in that the polymer contains at least 1 mol % of condensed aromatic ring systems.

24. The system as claimed in claim 21, wherein the sensitizer contains at least one heavy atom having an atomic number of greater than 38.

25. The system as claimed in claim 21, wherein the polymer is conjugated.

26. The system as claimed in claim 21, wherein the triplet level of the sensitiser is at least 0.05 eV higher than the triplet level of the polymer.

27. The system as claimed in claim 26, wherein the triplet level of the sensitizer is at least 0.1 eV higher than the triplet level of the polymer.

28. The system as claimed in claim 22, wherein the proportion of condensed aromatic ring systems is 5-80 mol %.

29. The system as claimed in claim 28, wherein the proportion of condensed aromatic ring systems is 10 to 50 mol %.

30. The system as claimed in claim 22, wherein the condensed aromatic ring systems are incorporated into the polymer main chain.

31. The system as claimed in claim 22, wherein the condensed aromatic ring systems contain between two and eight aromatic units, which are in each case condensed onto one another via one or more common edges and thus form a common aromatic system and which is optionally substituted or unsubstituted, where the substituents may form further ring systems.

32. The system as claimed in claim 31, wherein the condensed aromatic ring systems contain between three and five aromatic units, which are in each case condensed onto one another via one or more common edges and thus form a common aromatic system and which is optionally substituted or unsubstituted, where the substituents may form further ring systems.

33. The system as claimed in claim 31, wherein the aromatic units condensed onto one another are benzene, pyridine, pyrimidine, pyrazine, pyridazine or thiophene, each of which may be substituted or unsubstituted.

34. The system as claimed in claim 31, wherein the condensed aromatic ring systems are selected from structures of the formulae (1) to (24):

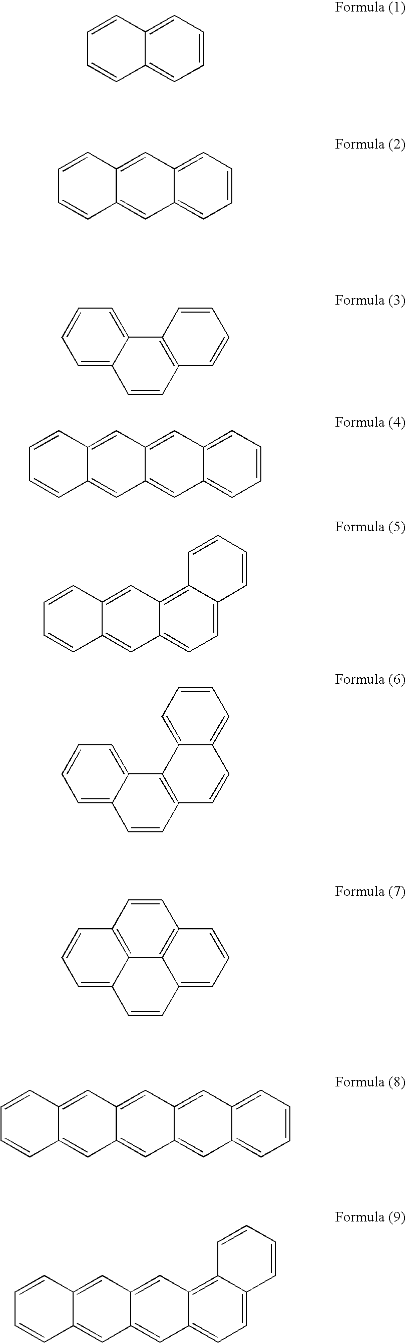

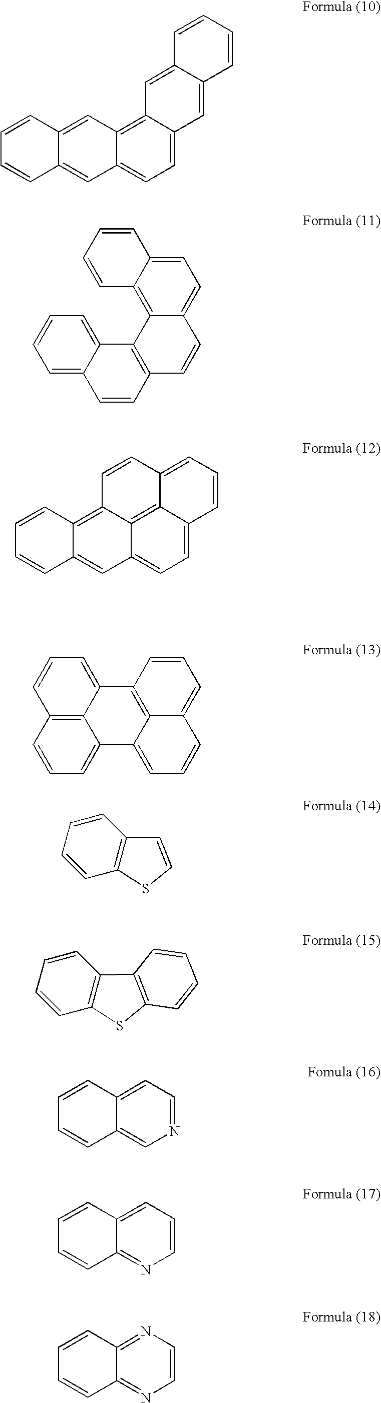

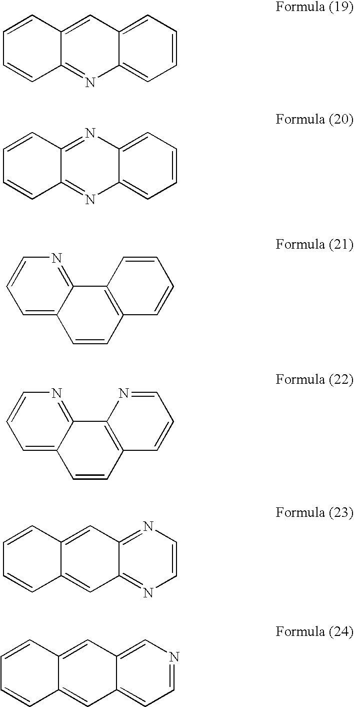

35. The system as claimed in claim 22, wherein the besides the condensed aromatic ring systems, the polymers also contain further structural elements which are fluorene derivatives, spirobifluorene derivatives, 1,4-phenylene derivatives, dihydrophenanthrenylene derivatives, tetrahydropyrenylene derivatives, 4,4′-biphenylylene derivatives, 4,4″-terphenylylene derivatives, indenofluorenylene derivatives, 4,4′-stilbenyl derivatives, 4,4″-bisstyrylarylene derivatives, tolanylene derivatives or mixtures thereof.

36. The system as claimed in claim 22, wherein the polymer contains metal complexes bonded into the main chain or side chain.

37. A system for up-conversion comprising at least one polymer and at least one sensitizer containing at least one heavy atom, characterised in that the polymer contains at least 1 mol % of condensed aromatic ring systems.

38. Optical and/or electronic devices for up-conversion containing at least one system according to claim 22.

39. Optical and/or electronic devices for up-conversion containing at least one system according to claim 37.

40. Optical and/or electronic device according to claim 39, wherein the device is an organic solar cell, an organic light-emitting diode or an organic laser.
